(19) United States
(12) Patent Application Publication
(10) Pub. No.: US 2006/0198374 A1
(43) Pub. Date: Sep. 7, 2006

(54) Special format computer network address for use with a computer network

(75) Inventors: Jae-Sun Chin, Helotes, TX (US); Edward Walter, Boerne, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/074,294

(22) Filed: Mar. 7, 2005

(51) Int. Cl. H04L 12/56; H04L 12/28

(52) U.S. Cl. 370/392; 370/401

(57) ABSTRACT

A computer network address for use in connection with a computer network is disclosed. The computer network address comprises an application name field, a private network address to identify a destination node within a remote network for which the application identified by the application name field is to be executed, a delimiter symbol, and a unique internet protocol address of a remotely located gateway. The remotely located gateway receives a routed data item before the routed data item is forwarded to the destination node within the remote network. The delimiter symbol is to separate the private network address from the unique internet protocol address of the remotely located gateway.

### FIELD OF THE DISCLOSURE

The present disclosure is generally related to computer networks and to computer network address resolution.

### BACKGROUND

Internet protocol (IP) addresses are used to communicate among various IP devices. In order for such devices to communicate, the IP address is to be unique. With private addresses, security and scalability for private networks is offered. However, problems arise when these private networks need to communicate with each other. A common technique to solve this problem for private networks is to use network address translation (NAT). For example, if two different customers have an internal application server with the same IP address, each of the customers configures a static address translation through their firewall or router. As businesses conduct additional business-to-business communication, network address translation becomes complicated and unmanageable. For each two-way connection, each customer is required to create a network address translation on the router or firewall. This leads to errors and difficulty in troubleshooting network problems and increased costs of overall network management.

Accordingly, there is a need for an improved method and system of communicating using computer network addresses.

### BRIEF DESCRIPTION OF THE DRAWINGS

FIG. 1 is a general diagram of a computer network.

FIG. 2 is a general diagram of a network address for use in connection with the network of FIG. 1.

FIG. 3 is a flow chart to illustrate a method of using the network address of FIG. 2.

### DETAILED DESCRIPTION OF THE DRAWINGS

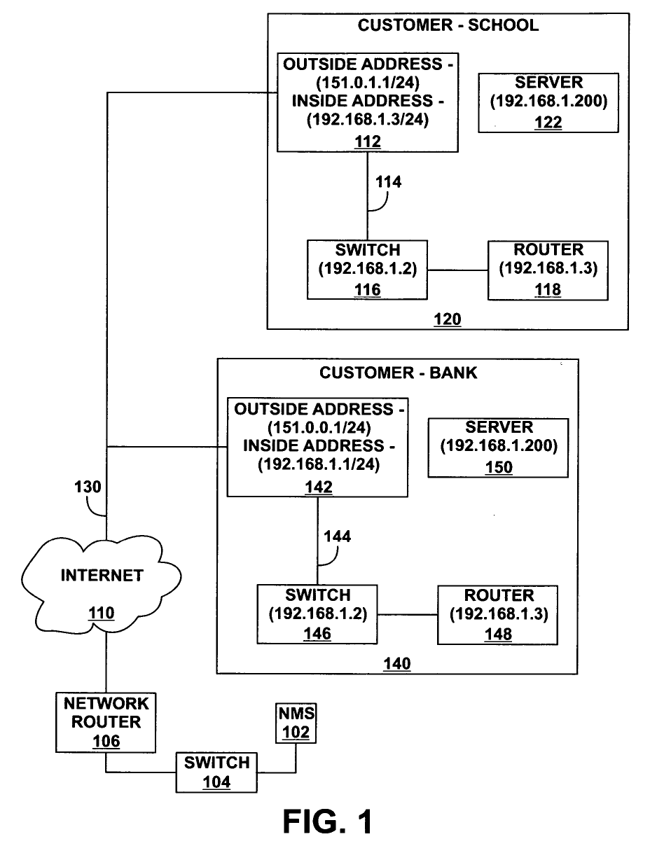

Referring to FIG. 1, an illustrative embodiment of a distributed computer network where network addresses are used is shown. The computer network includes a distributed network, such as the Internet 110, a network router 106, a switch 104, and a network management system 102. The network management system 102 is coupled to switch 104 and to network router 106, which is in turn coupled via the Internet to remote locations 120 and 140. For example, a first remote location 120 may be a first customer, such as a school as shown. As another example, a second customer may be a bank, as shown at location 140.

The first customer at location 120 includes a gateway router 112 coupled via a data connection 130 to the public network 110. The first customer location 120 further includes an internal network connection 114 between the publicly accessible router 112 and an internal private network switch 116 and a private router 118. The private network also includes an internal server 122 as shown.

Similarly, the illustrated second customer location 140 includes internal network connection 144 coupling a publicly accessible gateway router 142 to an internal private network switch 146 and to a private network router 148 coupled thereto. The second customer location 140 also includes an internal server 150.

The gateway router 112 at the first customer location 120 has an external network address (151.0.1.1/24) and includes an internal address (192.168.1.3/24). The external address is publicly viewable when used by external systems such as the network management system 102 to route data traffic to the location 120. The internal address of the gateway router 112 is an address of the internal private network and is used for internal data traffic routing inside the private network (i.e. inside the protective security firewall). The elements within the internal private network, such as the router 118 and the server 120, include private network addresses as shown.

In a similar manner, the second customer location 140 includes elements having internal addresses such as switch 146, router 148 and server 150. In addition, the gateway router 142 includes both an external address and an internal address as discussed above with respect to the first location 120.

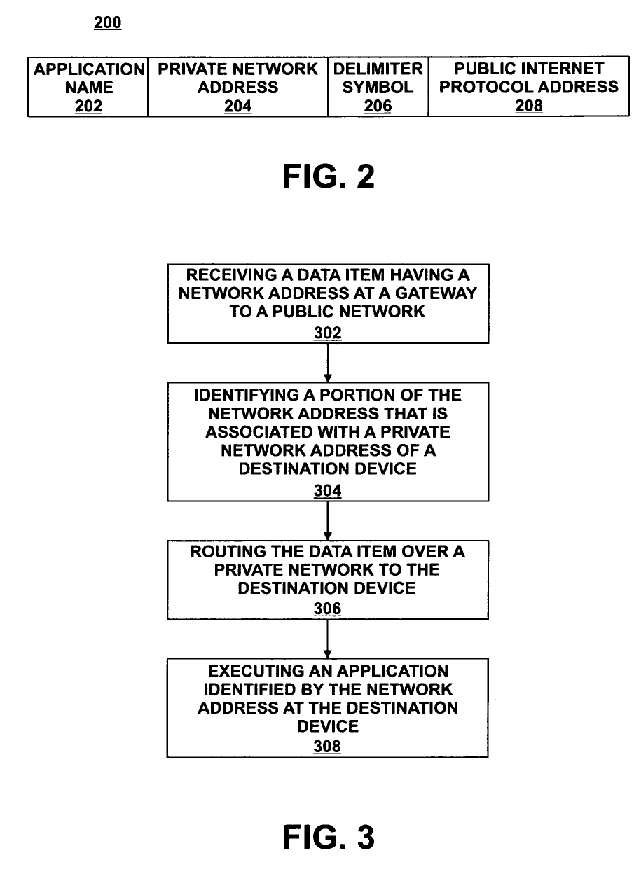

In the particular illustrative embodiment shown, the internal network address of the first server 122 at the first customer location 120 is the same as the internal network address of the second server 150 within the second customer location 140. Since both servers have the same network address, to the extent that the first customer communicates with the second customer over the public network connection 130, the network address destinations could be confused. In addition, with respect to a network management system 102 having connections to both customer locations 120 and 140, the centralized network management system 102 desires to provide unique communication identifiers for each of the servers 122 and 150. To address this complexity and common address problem, the system 102 may utilize an application routing (layer 7 routing) methodology. With the application layer 7 routing method, when the second customer 140 desires to access the server at the first customer location 120, the application may attempt to connect to the server 122 using a special formatted network address. In a particular embodiment, the special format for the network address includes an application name field followed by a private network address followed by a delimiter symbol, such as the “1” (at) symbol, followed by a publicly accessible IP address. An example of the network address format is shown with respect to FIG. 2. As an example, the following network addresses in such format is shown for illustration purposes.

| | |
|---|---|
| Ping | 192.168.1.1@151.0.0.1 |
| Ping | 192.168.1.3@151.0.1.1 |
| Telnet | 192.168.1.3@151.0.0.1 |
| Telnet | 192.168.1.3@151.0.1.1 |
| SNMP | 192.168.1.3@151.0.0.1 |
| SNMP | 192.168.1.3@151.0.1.1 |
| FTP | 192.168.1.3@151.0.0.1 |
| FTP | 192.168.1.3@151.0.1.1 |

Where a particular location, such as the second customer bank location 140 does business with many different schools or other destinations and desires to access various servers at such locations, the bank customer 140 may access such servers by connecting to the server using the address of the private server address at the identified public gateway address. This method provides a scalable technique to interconnect private networks without the need for complex NAT and routing. In addition, this method allows for many service providers, such as a service provider using network management system 102, to communicate and monitor many servers such as servers for a plurality of different customers, even those having the same internal addresses.

As illustrated, the format of the network address for a data connection may be in the form of an internal address followed by an “@” (at) symbol and followed by an external address. With such a formatted address, the connection is first routed to the external address that is a publicly available and unique address. Once a connection is received by a target device at the external address, a particular router or firewall may look at its access control list to determine whether a connection is permitted. If an internal destination connection is permitted, the target device at the external address will route the data to the private internal address. Once a destination server receives a connection, the server replies back to the external target address. This routing device may then forward the communication back to the original requesting device over the public network. Each application for the originating destination and intermittent devices will have capability and logic to handle layer 7 routing and properly process the network addresses in such special format.

Referring to FIG. 2, an illustrative example of a network address is shown. The computer network address 200 may be used in connection with a computer network. The computer network address 200 includes a first field 202 that identifies an application name, a second field 204 that identifies a private network address, a delimiter symbol field 206, such as the “1” (at) symbol, and a third field 208 that identifies a unique publicly accessible internet protocol (IP) address. Examples of suitable applications may be identified by the application name field 202, such as the Ping application, the Telnet application, the SNMP application, and a file transfer protocol (FTP) application.

Referring to FIG. 3, an illustrative method of operation using the computer network address described above is shown. The method includes receiving a data item associated with a particular network address at a gateway having access to a public data network, as shown at 302. For example, a gateway router at a customer location may receive a connection request and an associated data item having the formatted network address, as shown with respect to FIG. 2. The method further includes identifying a portion of the network address, such as the private network address field 204 that is associated with an internal private network address of a destination device at the customer location, as shown at 304. For example, with the first customer location 120, the internal device server 122 may be identified by the private network address field 204 of the computer network address 200. The method further includes routing the data item request over a private network to the destination device identified by the private network address, as shown at 306. For example, the first private network server 122 at the first customer location 120 may receive a data item forwarded from the gateway router 122 over switch 116 and internal router 118. The method further includes processing the data item received at the destination, such as by executing an application that is identified by a portion of the network address such as the application name field 202, as shown at step 308.

The disclosed system and method addresses the need to resolve complicated network address translation issues with business to business private network communications over intervening public data networks. The disclosed approach also allows managed service providers (MSP) that need to access their customer's internal network without requiring complex NAT and routing problems when accessing destination devices within different customer networks that have the same internal address. By using layer 7 routing and the identified computer network address format illustrated herein, the MSP may offer a scalable system that addresses the duplicate/overlapping IP address problem. In addition, the layer 7 routing approach allows for different applications, such as the Telnet, FTP, or Ping application to be utilized on a device of a remote network. Accordingly, an improved system and method of communicating between private networks has been disclosed.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer network address for use in connection with a computer network, the computer network address comprising:
an application name field;
a private network address to identify a destination node within a remote network for which the application identified by the application name field is to be executed;
a delimiter symbol; and
a unique internet protocol address of a remotely located gateway, the remotely located gateway to receive a routed data item before the routed data item is forwarded to the destination node within the remote network;
wherein the delimiter symbol is to separate the private network address from the unique internet protocol address of the remotely located gateway.

2. The computer network address of claim 1, wherein the application name field identifies a Ping application.

3. The computer network address of claim 1, wherein the application name field identifies an FTP application.

4. The computer network address of claim 1, wherein the application name field identifies a Telnet application.

5. The computer network address of claim 1, wherein the application name field identifies an SNMP application.

6. The computer network address of claim 1, wherein the delimiter symbol is an “@” (at) sign.

7. A computer device coupled to a computer network, the computer device comprising:
a processor to execute a computer program;
a computer readable memory including the computer program and storing a computer network address, the computer network address comprising:
an application name field associated with the computer program;
a private network address to identify a destination node within a remote private network coupled to the computer network; and
a unique internet protocol address of a remotely located gateway, the remotely located gateway coupled to the computer network and to the remote private network.

8. The computer device of claim 7, wherein the computer network address further includes a delimiter symbol.

9. The computer device of claim 8, wherein the delimiter symbol is to separately identify the private network address from the unique internet protocol address of the remotely located gateway.

10. A computer system coupled to a computer network, the computer device comprising:
a processor to execute a computer program;
a computer readable memory including the computer program and storing a first computer network address and a second computer network address, the first computer network address comprising:
an application name field associated with the computer program;
a first private network address to identify a destination node within a first remote private network coupled to the computer network; and
a first internet protocol address of a first remotely located gateway, the first remotely located gateway coupled to the computer network and to the first remote private network;
the second computer network address comprising:
an application name field associated with the computer program;
a second private network address to identify a destination node within a second remote private network coupled to the computer network; and
a second internet protocol address of a second remotely located gateway, the second remotely located gateway coupled to the computer network and to the second remote private network;
wherein the first private network address is the same as the second private network address but wherein the first internet protocol address of the first remotely located gateway is distinct from the second internet protocol address of the second remotely located gateway.

11. The computer system of claim 10, wherein the first private network address is an internal internet protocol address of the destination node within the first remote private network and the second private network address is an internal internet protocol address of the destination node within the second remote private network.

12. The computer system of claim 10, wherein the computer network is the internet and wherein the computer device is coupled to the internet by a data router and a switch.

13. The computer system of claim 12, wherein the first remote private network includes a router coupled to the internet and includes an internal switch coupled to the router by an internal network.

14. The computer system of claim 13, wherein the destination node within the first remote private network is a server computer having access to the internal network.

15. The computer system of claim 14, wherein the internal network is isolated from the internet by a firewall.
